(19) United States
(12) Patent Application Publication
(10) Pub. No.: US 2010/0085913 A1
(43) Pub. Date: Apr. 8, 2010

(54) SYSTEM ACQUISITION WITH INTERFERENCE CANCELLATION IN THE PRESENCE OF FEMTOCELLS

(75) Inventor: Parvathanathan Subrahmanya, Sunnyvale, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/496,331

(22) Filed: Jul. 1, 2009

Related U.S. Application Data
(60) Provisional application No. 61/077,538, filed on Jul. 2, 2008.

(51) Int. Cl. H04W 4/00; H04B 1/00; H04M 1/00

(52) U.S. Cl. 370/328; 455/63.1; 455/550.1

(57) ABSTRACT

Systems and methodologies are described that facilitate acquisition of a cell in the presence of interfering cells. An undesired cell in close proximity to a user equipment unit (UE) can inhibit detection of a desired cell. For instance, a femto cell near the UE can interfere with detection and acquisition of a macro cell. The UE can detect the undesired cell and reconstruct an estimate of signals transmitted by the undesired cell. The estimate can be employed to cancel interference from received signals to facilitate acquisition of a desired cell.

### CROSS-REFERENCE TO RELATED APPLICATIONS

This application claims the benefit of U.S. Provisional Patent application Ser. No. 61/077,538 entitled “SYSTEM ACQUISITION WITH INTERFERENCE CANCELLATION IN THE PRESENCE OF FEMTOCELLS” which was filed Jul. 2, 2008. The entirety of the aforementioned application is herein incorporated by reference.

### BACKGROUND

I. Field

The following description relates generally to wireless communications, and more particularly to enabling mobile devices to employ interference cancellation mechanisms to acquire cells in the presence of one or more femto cells.

II. Background

Wireless communication systems are widely deployed to provide various types of communication content such as voice and data, Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), LTE Advanced (LTE-A), etc.

As the demand for high-rate and multimedia data services rapidly grows, there has been an effort toward implementation of efficient and robust communication systems with enhanced performance. For example, in recent years, users have started to replace fixed line communications with mobile communications and have increasingly demanded great voice quality, reliable service, and low prices.

In addition to mobile telephone networks currently in place, a new class of small base stations has emerged, which can be installed in the home of a user and provide indoor wireless coverage to mobile units using existing broadband Internet connections. Such personal miniature base stations are generally known as access point base stations, or, alternatively, Home Node B (HNB) or Femto cells. Typically, such miniature base stations are connected to the Internet and the network of a mobile operator via a Digital Subscriber Line (DSL) router, cable modem, or the like.

Wireless communication systems can be configured to include a series of wireless access points, which can provide coverage for respective locations within the system. Such a network structure is generally referred to as a cellular network structure, and access points and/or the locations they respectively serve in the network are generally referred to as cells.

Because the strength of a signal typically decreases as the distance over which it is communicated increases, a network user can, under various circumstances, exchange substantially strong signals with cells located physically close to the user as compared to cells that are located farther away from the user. However, for various reasons, a user may not communicate with a wireless communication system through the cell closest to the user. For example, due to differences in capabilities of respective cells in the network, a cell closest to a user may be unable to provide a desired service to a user or may only be capable of providing the service with a lesser quality than a cell located further away. As another example, a closest cell to a user may have restricted access such that the user is not authorized to connect to the cell.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a method that facilitates employing interference cancellation during system acquisition is described herein. The method can comprise detecting at least one undesired cell in a wireless communication network. The method can also include estimating a signal transmitted by the at least one undesired cell. In addition, the method can comprise subtracting the estimated signal from a total received signal to produce a clean signal. Further, the method can include acquiring a desired cell in the wireless communication network with the clean signal.

A second aspect described herein relates to an apparatus. The apparatus can comprise a detection module that identifies signals transmitted by an interfering base station. The apparatus can also include an estimation module that generates an approximation of signals transmitted by the interfering base station. In addition, the apparatus can comprise a cancellation module that subtracts the approximation of signals from a total received signal.

A third aspect relates to a wireless communication apparatus that facilitates interference cancellation. The wireless communication apparatus can comprise means for detecting at least one undesired cell in a wireless communication network. The wireless communication apparatus can further include means for estimating a signal transmitted by the at least one undesired cell. In addition, the wireless communication apparatus can comprise means for subtracting the estimated signal from a total received signal to produce a clean signal. The wireless communication apparatus can also include means for acquiring a desired cell in the wireless communication network with the clean signal.

A fourth aspect described herein relates to a computer program product, which can comprise a computer-readable medium that comprises code for causing at least one computer to identify signals transmitted by an interfering base station. The computer-readable medium can further include code for causing the at least one computer to generate a signal approximation of signals transmitted by the interfering base station. In addition, the computer-readable medium can also include code for causing the at least one computer to cancel the signal approximation from a total received signal.

A fifth aspect relates to a wireless communication apparatus comprising a processor configured to detect at least one undesired cell in a wireless communication network. The processor can further configured to reconstruct an approximate signal transmitted by the at least one undesired cell. In addition, the processor can be configured to subtract the approximate signal from a total received signal to produce a clean signal. The processor can be further configured to acquire a desired cell in the wireless communication network with the clean signal.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 illustrates an example wireless communication system in accordance with various aspects set forth herein.

FIG. 3 is an illustration of an example system that facilitates acquisition of a base station in the presence of an interfering cell in accordance with various aspects.

FIG. 4 is an illustration of an example wireless communication system that facilitates cancellation of interference from received signals to enable acquisition of a base station in accordance with various aspects.

FIG. 5 is an illustration of an example system that facilitates cancellation of interfering base stations in accordance with various aspects.

FIG. 6 is an illustration of an example methodology that facilitates acquisition of a cell in the presence of interference in accordance with various aspects.

FIG. 7 is an illustration of an example methodology that facilitates cancellation of signals from an undesired strong cell in accordance with various aspects.

FIG. 8 is an illustration of an example system that enables interference cancellation in accordance with an aspect.

FIGS. 9-10 are block diagrams of respective wireless communication devices that can be utilized to implement various aspects of the functionality described herein.

FIG. 11 is a block diagram illustrating an example wireless communication system in which various aspects described herein can function.

FIG. 12 illustrates an example communication system that enables deployment of access point base stations within a network environment.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to computer-related entities such as: hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as, in accordance with a signal, having one or more data packets (e.g., data from one component interacting with another component in a local system, distributed system, and/or across a network such as the Internet with other systems by way of the signal).

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Node B) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various techniques described herein can be used for various wireless communication systems, such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier FDMA (SC-FDMA) systems, and other such systems. The terms “system” and “network” are often used herein interchangeably. A CDMA system can implement a radio technology such as Universal Terrestrial Radio Access (UTRA), CDMA2000, etc. UTRA includes Wideband-CDMA (W-CDMA) and other variants of CDMA. Additionally, CDMA2000 covers the IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Further, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

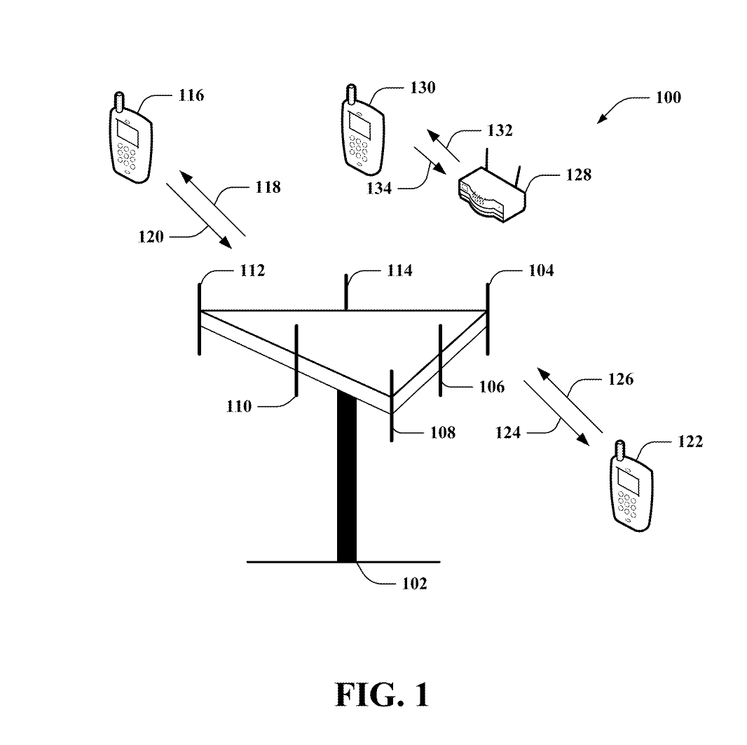

Referring now to FIG. 1, a wireless communication system 100 is illustrated in accordance with various embodiments presented herein. System 100 comprises an eNB 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. eNB 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

eNB 102 can communicate with one or more UEs such as UE 116 and UE 122; however, it is to be appreciated that eNB 102 can communicate with substantially any number of UEs similar to UEs 116 and 122. UEs 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, UE 116 is in communication with antennas 112 and 114, where antennas 112 and 114 transmit information to UE 116 over a downlink 118 and receive information from UE 116 over an uplink 120. Moreover, UE 122 is in communication with antennas 104 and 106, where antennas 104 and 106 transmit information to UE 122 over a downlink 124 and receive information from UE 122 over an uplink 126. In a frequency division duplex (FDD) system, downlink 118 can utilize a different frequency band than that used by uplink 120, and downlink 124 can employ a different frequency band than that employed by uplink 126, for example. Further, in a time division duplex (TDD) system, downlink 118 and uplink 120 can utilize a common frequency band and downlink 124 and uplink 126 can utilize a common frequency band.

Each group of antennas and/or the area in which they are designated to communicate can be referred to as a sector of eNB 102. For example, antenna groups can be designed to communicate to UEs in a sector of the areas covered by eNB 102. In communication over downlinks 118 and 124, the transmitting antennas of eNB 102 can utilize beamforming to improve signal-to-noise ratio of downlinks 118 and 124 for UEs 116 and 122. Also, while eNB 102 utilizes beamforming to transmit to UEs 116 and 122 scattered randomly through an associated coverage, UEs in neighboring cells can be subject to less interference as compared to an eNB transmitting through a single antenna to all its UEs. Moreover, UEs 116 and 122 can communicate directly with one another using a peer-to-peer or ad hoc technology (not shown).

According to an example, system 100 can be a multiple-input multiple-output (MIMO) communication system. Further, system 100 can utilize substantially any type of duplexing technique to divide communication channels (e.g., downlink, uplink, . . . ) such as FDD, FDM, TDD, TDM, CDM, and the like. In addition, communication channels can be orthogonalized to allow simultaneous communication with multiple devices or UEs over the channels; in one example, OFDM can be utilized in this regard. Thus, the channels can be divided into portions of frequency over a period of time. In addition, frames can be defined as the portions of frequency over a collection of time periods; thus, for example, a frame can comprise a number of OFDM symbols. The eNB 102 can communicate to the UEs 116 and 122 over the channels, which can be created for various types of data. For example, channels can be created for communicating various types of general communication data, control data (e.g., quality information for other channels, acknowledgement indicators for data received over channels, interference information, reference signals, etc.), and/or the like.

In one example, the eNB 102 can be a macro cell eNB, and a small scale eNB 128 is provided, which can be a femto cell eNB, pico cell eNB, relay node, and/or the like. In one example, the small scale eNB 128 can communicate with UEs using similar technology to that of the eNB 102. For example, the small scale eNB 128 can define channels over radio communication as well and can transmit to one or more UEs, such as UE 130, over a downlink 132 while receiving over an uplink 134. In attempting to acquire the small scale eNB 128, UE 130 can experience interference created by eNB 102, for example. Alternatively, UE 116 and/or UE 122 can experience interference from the small scale eNB 128 while attempting to acquire service via the eNB 102. For instance, the small scale eNB 128 can be in close proximity to UE 116 and/or UE 122 such that signals from the small scale eNB 128 appear much stronger to UE 116 and/or UE 122 than signals from eNB 102. UE 116 and 122 can detect the small scale eNB 128 (e.g., detect a scrambling code) and generate an estimate of signals emitted by the small-scale eNB 128. The estimated signal can be subtracted from a total received signal to facilitate detection of eNB 102.

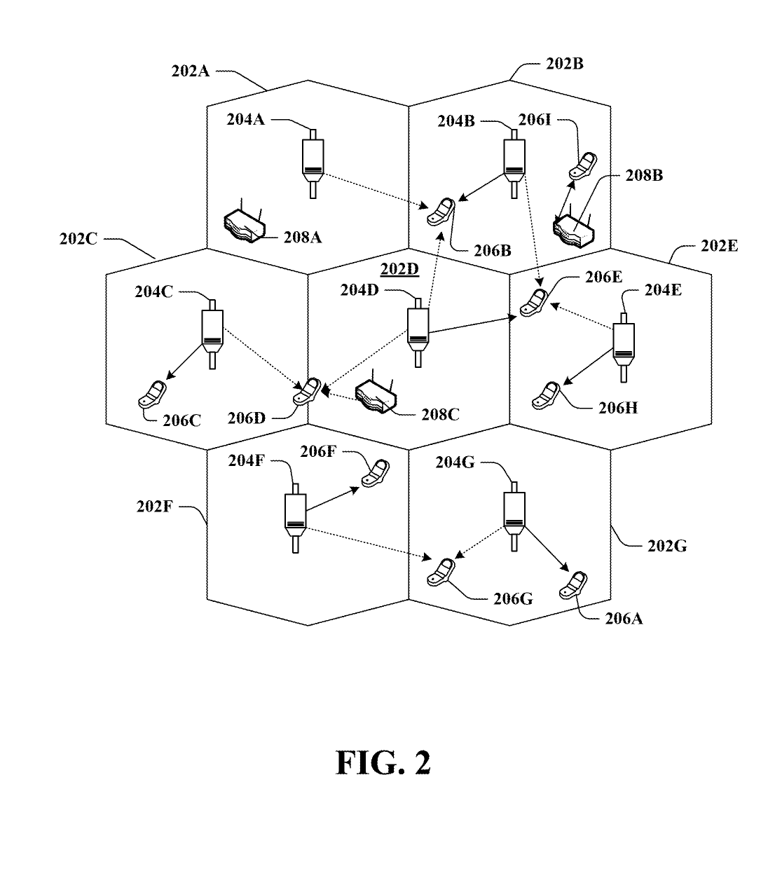

Now referring to FIG. 2, a wireless communication system 200 configured to support a number of UEs is illustrated. The system 200 provides communication for multiple cells, such as for example, macro cells 202A-202G, with each cell being serviced by a corresponding eNB 204A-204G. As described previously, for instance, the eNBs 204A-204G related to the macro cells 202A-202G can be base stations or other access points. UEs 206A-206I are shown dispersed at various locations throughout the wireless communication system 200. Each UE 206A-206I can communicate with one or more eNBs 204A-204G on a downlink and/or an uplink, as described. In addition, eNBs 208A-208C are shown. These can be small scale eNBs, such as femto cell eNBs, pico cell eNBs, relay nodes, mobile base stations, and/or the like, offering services related to a particular service location, as described. The UEs 206A-206I can additionally or alternatively communicate with these small scale eNBs 208A-208C to receive offered services. The wireless communication system 200 can provide service over a large geographic region, in one example (e.g., macro cells 202A-202G can cover a few blocks in a neighborhood, and the small scale eNBs 208A-208C can be present in areas such as residences, office buildings, and/or the like as described). In an example, the UEs 206A-206I can establish connection with the eNBs 204A-204G and/or 208A-208C over the air and/or over a backhaul connection.

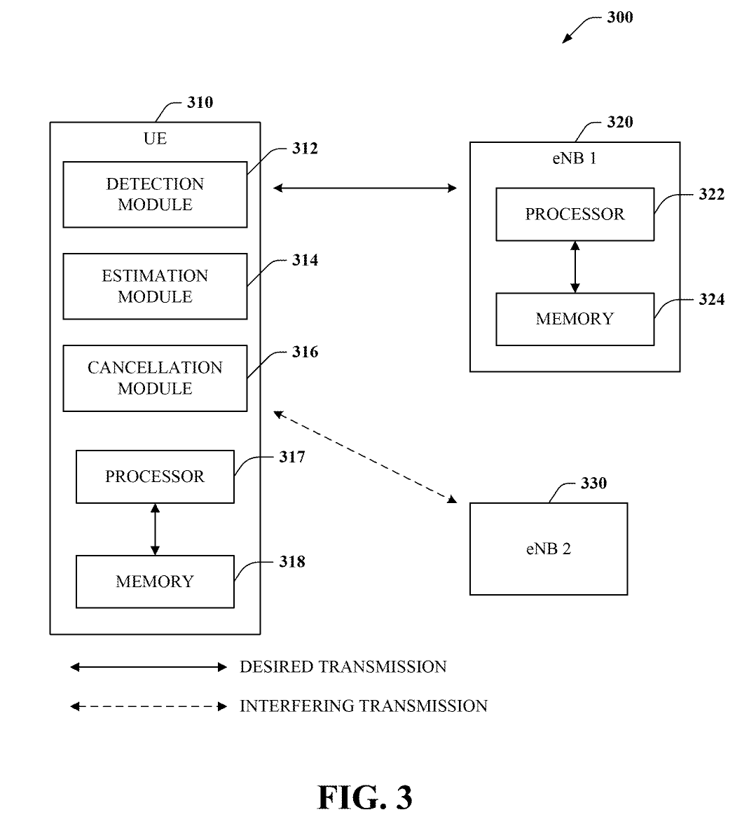

Turning to FIG. 3, illustrated is a wireless communication system 300 that facilitates acquisition of a base station (e.g., eNodeB, eNB, . . . ) in the presence of an interfering cell in accordance with various aspects. As FIG. 3 illustrates, system 300 can include one or more user equipment units (UEs) 310, which can communicate with one or more Evolved Node Bs (eNBs) 320 and/or 330. While only one UE 310 and two eNBs 320 and 330 are illustrated in FIG. 3, it should be appreciated that system 300 can include any number of UEs 310 and/or eNBs 320 and/or 330. Further, it can be appreciated that respective eNBs in system 300 can serve any suitable coverage area, such as an area associated with a macro cell, a femto cell (e.g., an access point base stations or Home Node B (HNB)), and/or any other suitable type of coverage area.

In accordance with one aspect, UE 310 can communicate with an eNB designated as a serving eNB for UE 310 (e.g., eNB 320). For example, UE 310 can conduct one or more uplink (UL, also referred to as reverse link (RL)) communications to eNB 320, and eNB can conduct one or more downlink (DL, also referred to as forward link (FL)) communications to UE 310. In the example illustrated by system 300, communications between UE 310 and eNB 320 are illustrated using a solid line. In one example, uplink and/or downlink communication between UE 310 and eNB 320 can additionally result in interference to nearby eNBs, such as eNB 330. For example, if the coverage areas of multiple eNBs in system 300 overlap, a UE located in an area that lies in an overlap between the coverage of multiple eNBs can cause interference to one or more eNBs within range of the UE with which the UE is not communicating under various circumstances. This can occur, for example, in a system that includes femto cells if a UE is located within the coverage area of a femto cell, which in turn is embedded into the coverage area of a macro cell.

In accordance with one aspect, as the strength of a signal generally decreases as the distance over which it is communicated increases, UE 310 can, under various circumstances, exchange substantially strong signals with eNBs 320 and/or 330 located physically close to UE 310 as compared to eNBs 320 and/or 330 that are located farther away from UE 310. However, various factors can cause UE 310 to select an eNB 320 and/or 330 other than an eNB 320 and/or 330 that is closest to UE 310 for communication within system 300. For example, as a result of differences in capabilities of respective eNBs, an eNB closest to a UE may be unable to provide a desired service or may only be capable of providing the service with a lesser quality than an eNB located further away. Such differences in eNB capability could result from, for example, different transmit power levels, backhaul implementations, numbers of antennas utilized, duplexing capabilities (e.g., half-duplex vs. full-duplex), or the like. As another example, a closest eNB to a UE may have restricted access (e.g., the eNB may correspond to a restricted association network) such that the UE is not authorized to connect to the eNB.

In one example, UE 310 can attempt acquisition of eNB 320 but experience high levels of interference from eNB 330. For instance, eNB 330 can be associated with a femto cell, which is a typically low power access point base station in a communication network. eNB 330 can include a closed subscriber group (CSG) such that a subscriber (e.g., UE 310) that is not a member of the CSG is not permitted to connect through eNB 330 to the communication network. In another example, the eNB 330 can transmit utilizing a same carrier frequency as eNB 320 resulting in interference. The interference can inhibit ability of UE 310 to receive signals from eNB 320. In some cases, the interference can reach levels that prevent detection and acquisition of eNB 320. For example, UE 310 can be in close proximity to eNB 330 but not a member of the associated CSG. It should be appreciated that similar interference can be caused by eNB 320 when UE 310 is a member of the CSG of eNB 330.

According to an aspect, UE 310 can be configured to function properly when attempting to access eNB 320 despite interference resulting from presence of eNB 330 that can utilize a similar carrier frequency as eNB 320. For example, UE 310 can employ interference cancellation techniques. UE 310 can include a detection module 312 that identifies signals transmitted by eNB 330. For instance, eNB 330 can be a femto cell or a macro cell in close proximity to UE 310 and, accordingly, interferes with acquisition of eNB 320. Once detected, UE 310 includes an estimation module 314 that generates an estimate of signals transmitted by eNB 330. For example, the estimation module 314 can code and modulate information received from eNB 330 to reproduce a signal similar to signals transmitted by eNB 330. UE 310 can utilize a cancellation module 316 to subtract or cancel the estimated signal from a total received signal to generate a clean signal. After signal cancellation, UE 310 can attempt to detect eNB 320. In one example, UE 310 can search for synchronization, pilot and/or reference signals transmitted by eNB 320. In addition, UE 310 can demodulate broadcast channels or other channels of eNB 320 involved in system acquisition.

As further illustrated in system 300, UE 310 can include a processor 317 and/or a memory 318, which can be utilized to implement some or all of the functionality of detection module 312, estimation module 314, cancellation module 316 and/or any other component(s) of UE 310. Similarly, FIG. 3 illustrates that eNB 320 can include a processor 322 and/or memory 324 to implement some or all of the functionality of eNB 220. While only eNB 220 is illustrated as including a processor 322 and memory 324 in FIG. 3, it should be appreciated that eNB 330 can additionally or alternatively implement a processor and/or memory in a similar manner.

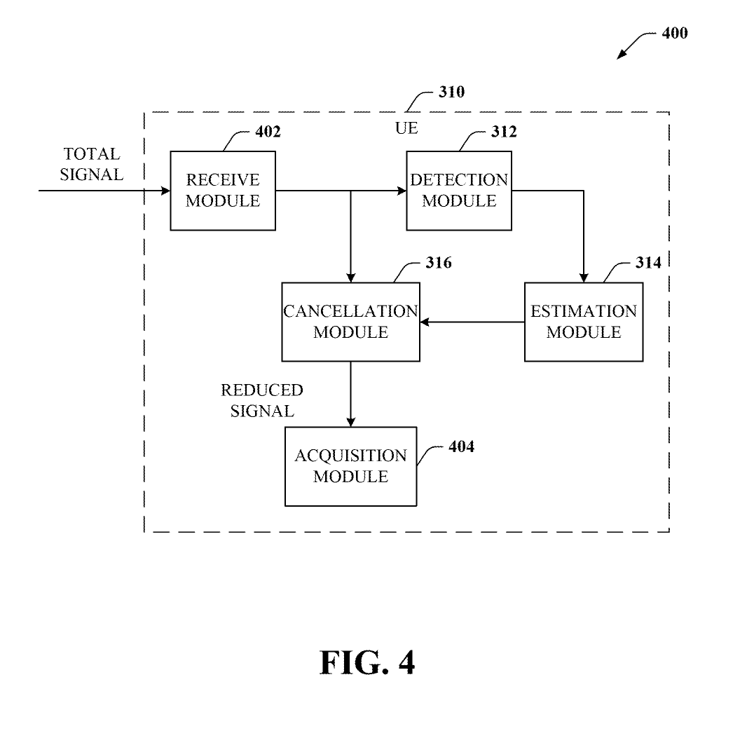

Referring now to FIG. 4, illustrated is a system 400 that facilitates cancellation of interference from received signals to enable acquisition of a base station in accordance with various aspects. System 400 includes UE 310 that utilizes signal cancellation mechanisms to reduce interference impeding acquisition of a desired cell. UE 310 can include a receive module 402 that obtains a total signal that includes signals transmitted by two or more base stations (e.g., eNodeBs, Home NodeBs, etc.). The base stations can be associated with macro cells, femto cells, pico cells, etc. In one example, UE 310 can attempt to acquire a base station associated with a macro cell while located in close proximity to a base station associated with a femto cell for which UE 310 is not a member of a respective subscriber group. Accordingly, the total signal obtained by UE 310 can include interference from the femto cell which prevents acquisition of the macro cell. In another example, the UE 310 can desire access to a femto cell but experience interference from a macro cell.

The receive module 402 can include components and/or devices such as processors, antennas, demodulators, decoders, etc., to facilitate reception of signals from two or more base stations. The total received signal can be provided to a detection module 312 to detect signals from an interfering base station (e.g., a base station not associated with a desired cell). In one example, the detection module 412 can analyze the total signal to detect a presence of a base station. When the detected base station is associated with a desired cell, UE 310 can proceed with system acquisition. However, an undesired cell (e.g., a femto cell for which the UE 310 is not authorized or macro cell interfering with a femto cell) can generate interference that prevents detection of a desired cell. When the detected base station is associated with an undesired cell, UE 310 performs interference cancellation.

UE 310 includes an estimation module 314 that generates or reconstructs an estimated or approximate signal similar to signals transmitted by the undesired cell. For example, the detection module 312 can identify or discover a scrambling code employed by the undesired cell. The estimation module 314 can utilize the scrambling code to create an approximation of the signal transmitted by the undesired cell. The reconstructed signal can be provided to a cancellation module 316 that subtracts the reconstructed signal, after appropriate scaling, from the total signal to generate a reduced signal that includes less interference from the undesired cell. The reduced signal generated by the cancellation module 316 can be utilized by UE 310 to search for a desired cell. For instance, the UE 310 can employ an acquisition module 404 to identify synchronization (e.g., primary and/or secondary synchronization signals) signals, pilot signals, and/or reference signals transmitted by a desired cell. Once appropriate signals have been identified, the acquisition module 404 can synchronize with the desired cell and receive and demodulate broadcast channels and/or other channels associated with system acquisition.

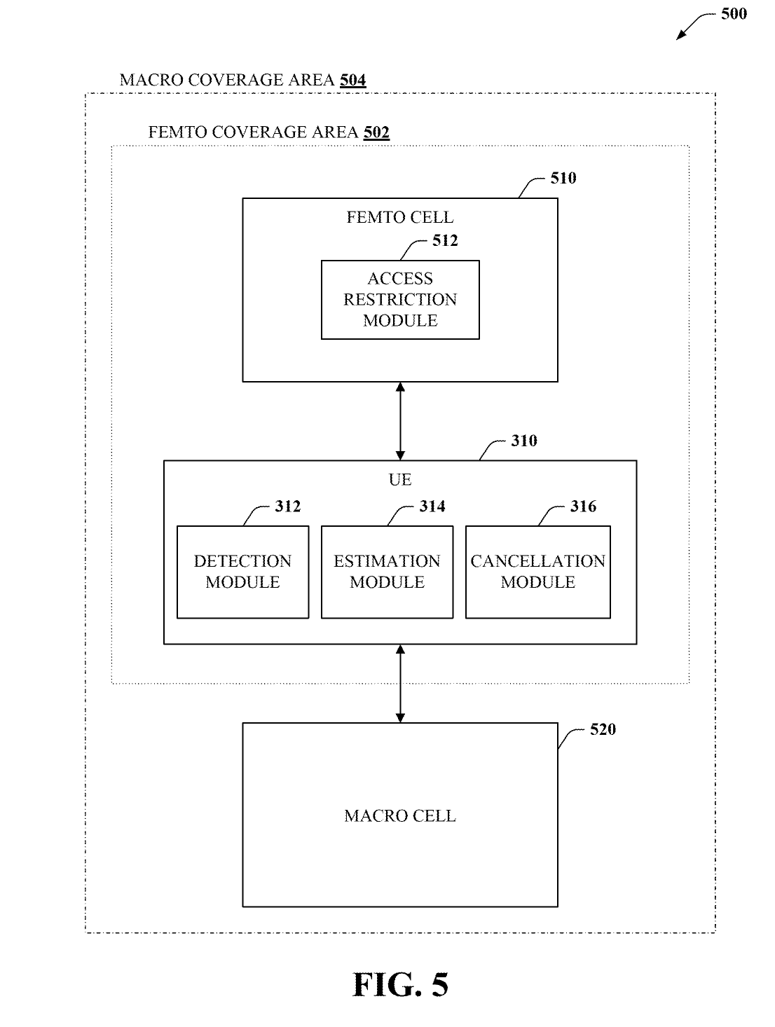

Turning to FIG. 5, a system 500 that facilitates cancellation of an interfering base station is illustrated. With regard to FIG. 5, it should be appreciated that the system 500 is provided as an example of a network structure that can utilize the cancellation techniques described herein and the claims are not limited to such a network structure.

As FIG. 5 illustrates, system 500 can include a femto cell 510 having an associated coverage area 502 and a macro cell 520 that is associated with a larger coverage area 504. In one example, the coverage area 502 of femto cell 510 can be embedded within the coverage area 504 of macro cell 520 such that the coverage area 502 of femto cell 510 is entirely contained within the coverage area 504 of macro cell 520. For example, femto cell 510 can provide communication coverage for a user residence and/or a similar area, and macro cell 520 can provide coverage for a group of residences that includes a residence associated with femto cell 510. However, it should be appreciated that the techniques described herein do not require the coverage area 502 of femto cell 510 to be located entirely within the coverage area 504 of macro cell 520 and that the techniques described herein can be utilized to facilitate acquisition of a desired cell when two or more cells having any degree of overlap.

In accordance with one aspect, femto cell 510 can be a restricted access network such that only UEs within a closed subscriber group (CSG) associated with femto cell 510 are allowed to access femto cell 510. Access control can be performed at femto cell 510 by, for example, an access restriction module 512 and/or any other suitable component associated with femto cell 510. Thus, if a given UE 310 within the coverage area 502 of femto cell 510 is not authorized to access femto cell 510, the UE 310 can be required to instead access a macro cell 520 that also provides coverage for the area in which UE 310 is located. In such an example, UE 310 can be in close proximity to femto cell 510 such that macro cell 520 is difficult to detect and/or acquire.

Accordingly, UE 310 can utilize detection module 312, estimation module 314, and cancellation module 316, and/or any other suitable functionality to perform interference cancellation on interference generated by femto cell 510. For example, UE 310 can detect the femto cell 510, reconstruct signals transmitted by femto cell 510, and subtract the reconstructed signals from a total received signal to facilitate detection of macro cell 520. It is to be appreciated that detection module 312, estimation module 314, and cancellation module 316 can be similar to and/or perform similar functionality as similarly designated modules described supra with reference to previous figures.

In accordance with another aspect, it is to be appreciated that such interference cancellation techniques can be employed to suppress signals from macro cell 520 during acquisition of femto cell 510. For instance, UE 310 can be within the CSG of femto cell 510 but be in sufficient proximity to macro cell 520 that detection and acquisition of femto cell 510 is hampered. UE 310 can employ the detection module 312, estimation module 314, and cancellation module 316, as described herein, to suppress signals of macro cell 520 to enable detection and acquisition of femto cell 510.

In another aspect, UE 310 can be surrounded by multiple femto cells (not shown). Accordingly, UE 310 can iteratively detect, estimate and cancel signals multiple times to successively improve a total received signal until detection and acquisition of macro cell 520 is possible. For instance, UE 310 can detect a first cell, estimate and suppress signals of the first cell. Subsequently, UE 310 can detect a second cell, estimate and suppress the respective signal. UE 310 can repeat the process until all cells undesired cells are detected and cancelled.

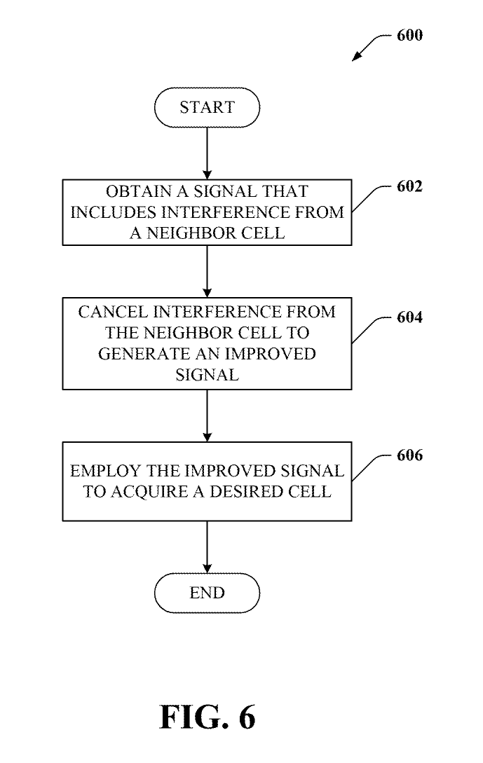

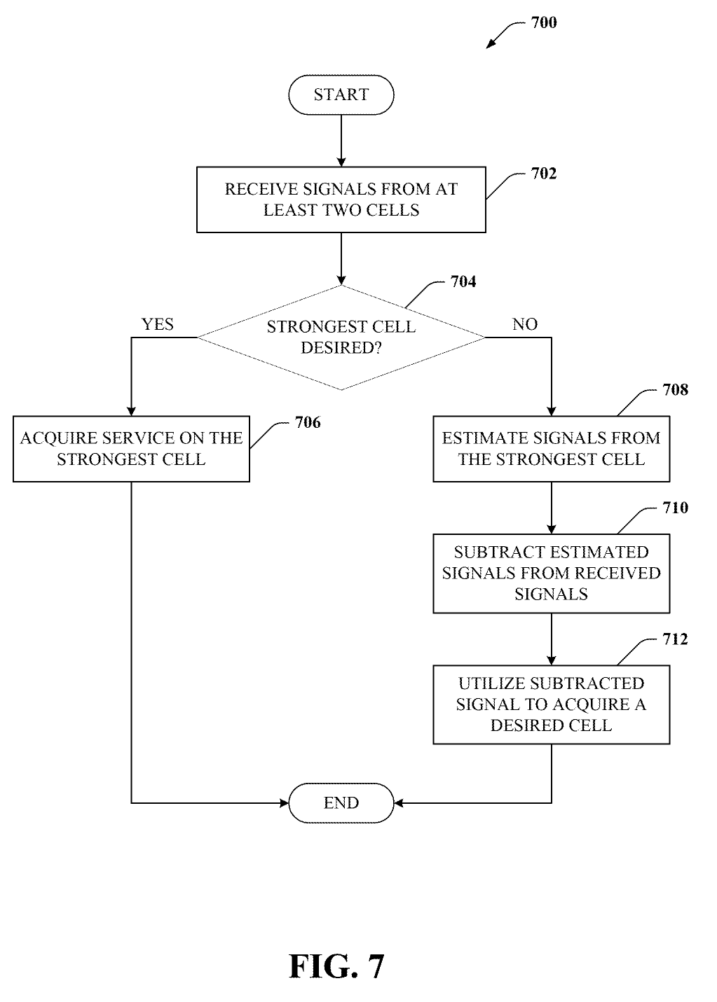

Referring to FIGS. 6-7, methodologies relating to cancellation of interference from undesired cells during system acquisition are described. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 6, illustrated is a method 600 that facilitates acquisition of a cell in the presence of interference in accordance with various aspects. Method 600 can be employed by, for example, a mobile device (e.g., user equipment (UE)) to subtract signals received from a detected undesired cell or base station. At reference numeral 602, a signal is received. The signal can be synchronization signals, pilot signals, and/or reference signals for a desired cell (e.g., eNodeB, Home Node B, etc.) with high levels interference from similar signals of an undesired cell. For instance, the undesired can be a femto cell in close proximity to a macrocellular UE. In particular, the femto cell can be a cell in which the macrocellular UE is not a member of the respective closed subscriber group and, therefore, cannot access a communications network through the femto cell. The undesired cell can generate high levels of interference in regard to signals form a desired cell such that a UE cannot detect the desired cell over the undesired cell.

At reference numeral 604, interference from the undesired cell is cancelled to generate an improved signal. In one example, a signal estimate or approximation of transmission from the undesired cell can be constructed. The signal approximation can be scaled and subtracted from a received signal. At reference numeral 606, the improved signal can be employed to detect and acquire the desired cell.

Referring to FIG. 7, illustrated is a method 700 that facilitates cancellation of signals from an undesired strong cell in accordance with various aspects. Method 700 can commence at reference numeral 702 where signals are received from at least two cells. In one example, the at least two cells can include an undesired femto cell and a desired macro cell. In another example, the at least two cells can include an undesired macro cell and a desired femto cell. At reference numeral 704, a determination is made as to whether a strongest cell in terms of signal strength received is a desired cell. A strongest cell can be ascertained based upon proximity and/or transmission power employed by cells. For example, a lower power cell in close proximity to a UE can appear to the UE as the strongest cell. If the strongest cell (e.g., cell readily detected based on the received signal) is a desired cell, the method 700 proceeds to reference numeral 706 where service is acquired on the strongest cell. If, at reference numeral 704, it is determined that the strongest cell is undesired, the method 700 proceeds to reference numeral 708 where signals from the strongest cell estimated. In one example, a scrambling code associated with the strongest cell can be detected and utilized to generate a signal approximation. At reference numeral 710, the estimated signal is subtracted from the received signal. At reference numeral 712, the reduced signal is utilized to acquire a desired cell.

It will be appreciated that, in accordance with one or more aspects described herein, inferences can be made regarding detecting cells (e.g., base stations, eNBs, HNBs, etc.), generating signal approximations, detecting cells in a subtracted signal, and the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

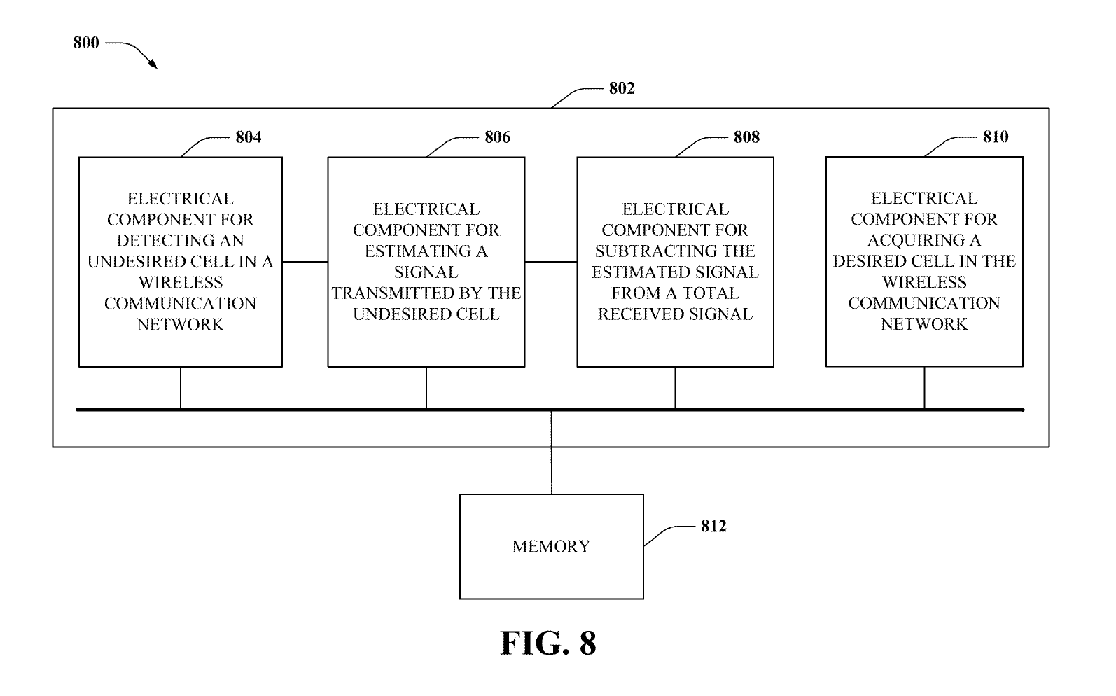

With reference to FIG. 8, illustrated is a system 800 that enables interference cancellation in accordance with an aspect For example, system 800 can reside at least partially within a user equipment unit. It is to be appreciated that system 800 is represented as including functional blocks, which can be functional blocks that represent functions implemented by a processor, software, or combination thereof (e.g., firmware). System 800 includes a logical grouping 802 of electrical components that can act in conjunction. For instance, logical grouping 802 can include an electrical component for detecting an undesired cell in a wireless communication network 804. Further, logical grouping 802 can comprise an electrical component for estimating a signal transmitted by the undesired cell 806. Moreover, logical grouping 802 can comprise an electrical component for subtracting the estimated signal from a total received signal 808. Logical grouping 1102 can also include an electrical component for acquiring a desired cell in the wireless communication network 810. Additionally, system 800 can include a memory 812 that retains instructions for executing functions associated with electrical components 804, 806, 808 and 810. While shown as being external to memory 812, it is to be understood that one or more of electrical components 804, 806, 808 and 810 can exist within memory 812.

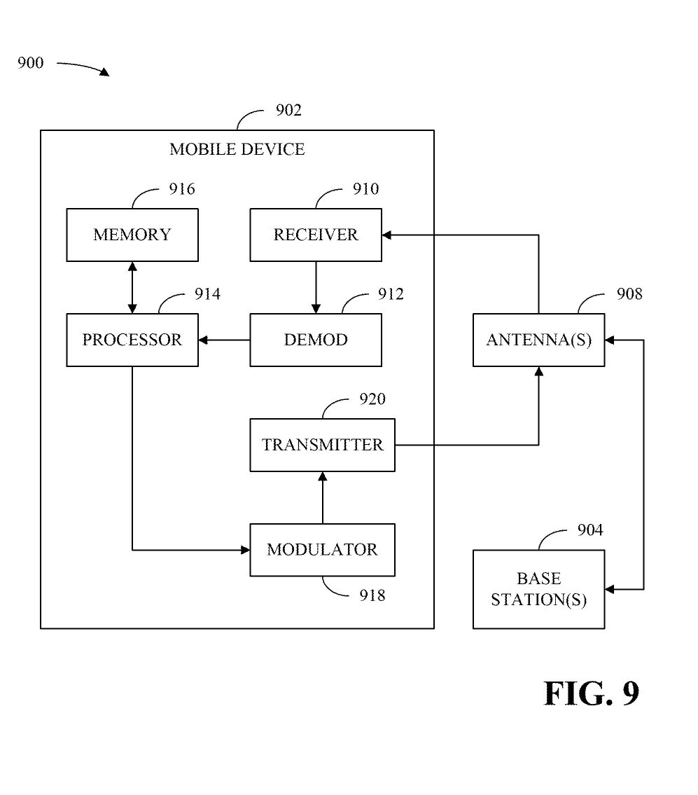

FIG. 9 is a block diagram of another system 900 that can be utilized to implement various aspects of the functionality described herein. In one example, system 900 includes a mobile device 902. As illustrated, mobile device 902 can receive signal(s) from one or more base stations 904 and transmit to the one or more base stations 904 via one or more antennas 908. Additionally, mobile device 902 can comprise a receiver 910 that receives information from antenna(s) 908. In one example, receiver 910 can be operatively associated with a demodulator (Demod) 912 that demodulates received information. Demodulated symbols can then be analyzed by a processor 914. Processor 914 can be coupled to memory 916, which can store data and/or program codes related to mobile device 902. Mobile device 902 can also include a modulator 918 that can multiplex a signal for transmission by a transmitter 920 through antenna(s) 908.

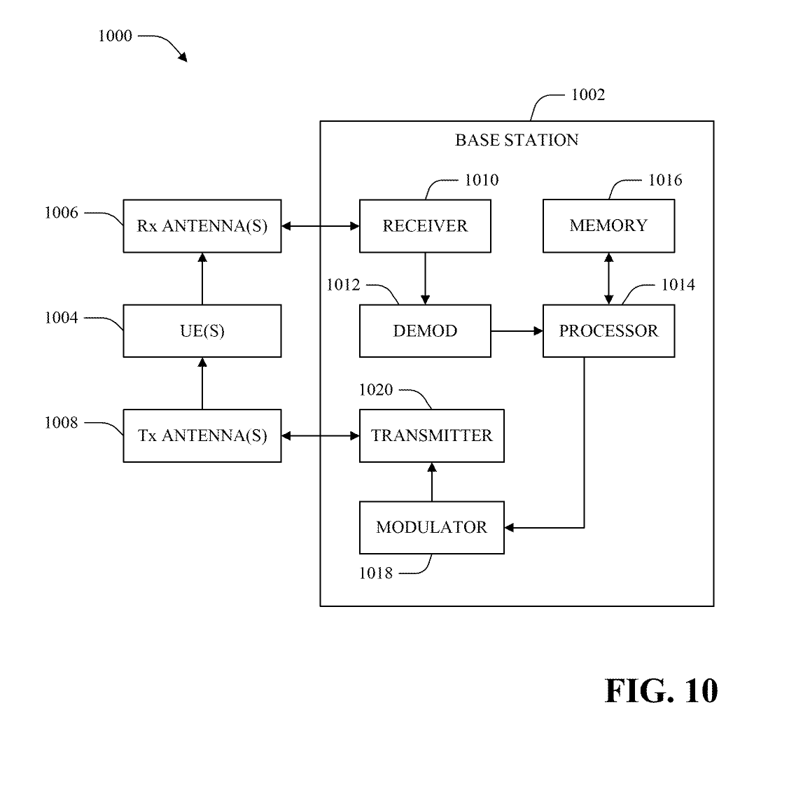

FIG. 10 is a block diagram of a system 1000 that can be utilized to implement various aspects of the functionality described herein. In one example, system 1000 includes a base station or base station 1002. As illustrated, base station 1002 can receive signal(s) from one or more UEs 1004 via one or more receive (Rx) antennas 1006 and transmit to the one or more UEs 1004 via one or more transmit (Tx) antennas 1008. Additionally, base station 1002 can comprise a receiver 1010 that receives information from receive antenna(s) 1006. In one example, the receiver 1010 can be operatively associated with a demodulator (Demod) 1012 that demodulates received information. Demodulated symbols can then be analyzed by a processor 1014. Processor 1014 can be coupled to memory 1016, which can store information related to code clusters, access terminal assignments, lookup tables related thereto, unique scrambling sequences, and/or other suitable types of information. In one example, base station 1002 can employ processor 1014 to perform method 700, and/or other similar and appropriate methodologies. Base station 1002 can also include a modulator 1018 that can multiplex a signal for transmission by a transmitter 1020 through transmit antenna(s) 1008.

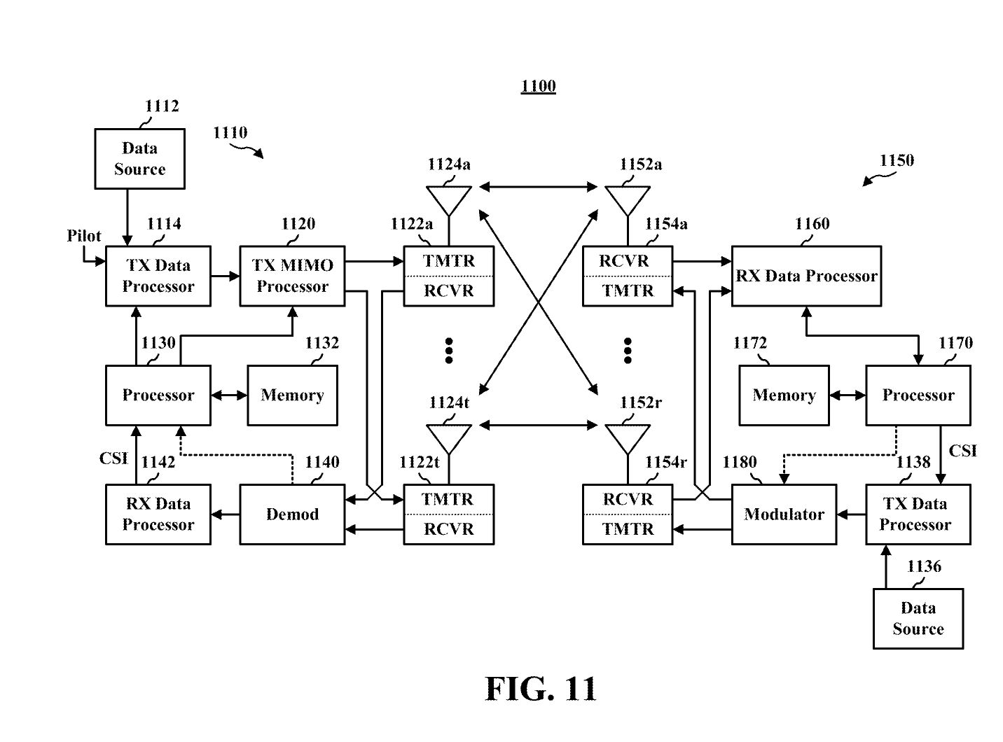

FIG. 11 shows an example wireless communication system 1100. The wireless communication system 1100 depicts one base station 1110 and one mobile device 1150 for sake of brevity. However, it is to be appreciated that system 1100 can include more than one base station and/or more than one mobile device, wherein additional base stations and/or mobile devices can be substantially similar or different from example base station 1110 and mobile device 1150 described below. In addition, it is to be appreciated that base station 1110 and/or mobile device 1150 can employ the systems (FIGS. 1, 2, 3, 4, 5 and 8-10) and/or methods (FIGS. 6-7) described herein to facilitate wireless communication there between.

At base station 1110, traffic data for a number of data streams is provided from a data source 1112 to a transmit (TX) data processor 1114. According to an example, each data stream can be transmitted over a respective antenna. TX data processor 1114 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1150 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1130.

The modulation symbols for the data streams can be provided to a TX MIMO processor 1120, which can further process the modulation symbols (e.g., for OFDM). TX MIMO processor 1120 then provides N_{T} modulation symbol streams to N_{T} transmitters (TMTR) 1122a through 1122t. In various embodiments, TX MIMO processor 1120 applies beamforming weights to the symbols of the data streams and to the antenna from which the symbol is being transmitted.

Each transmitter 1122 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1122a through 1122t are transmitted from N_{T} antennas 1124a through 1124t, respectively.

At mobile device 1150, the transmitted modulated signals are received by N_{R} antennas 1152a through 1152r and the received signal from each antenna 1152 is provided to a respective receiver (RCVR) 1154a through 1154r. Each receiver 1154 conditions (e.g., filters, amplifies, and downconverts) a respective signal, digitizes the conditioned signal to provide samples, and further processes the samples to provide a corresponding “received” symbol stream.

An RX data processor 1160 can receive and process the N_{R} received symbol streams from N_{R} receivers 1154 based on a particular receiver processing technique to provide N_{T} “detected” symbol streams. RX data processor 1160 can demodulate, deinterleave, and decode each detected symbol stream to recover the traffic data for the data stream. The processing by RX data processor 1160 is complementary to that performed by TX MIMO processor 1120 and TX data processor 1114 at base station 1110.

A processor 1170 can periodically ascertain which precoding matrix to utilize as discussed above. Further, processor 1170 can formulate a reverse link message comprising a matrix index portion and a rank value portion.

The reverse link message can comprise various types of information regarding the communication link and/or the received data stream. The reverse link message can be processed by a TX data processor 1138, which also receives traffic data for a number of data streams from a data source 1136, modulated by a modulator 1180, conditioned by transmitters 1154a through 1154r, and transmitted back to base station 1110.

At base station 1110, the modulated signals from mobile device 1150 are received by antennas 1124, conditioned by receivers 1122, demodulated by a demodulator 1140, and processed by a RX data processor 1142 to extract the reverse link message transmitted by mobile device 1150. Further, processor 1130 can process the extracted message to determine which precoding matrix to use for determining the beamforming weights.

Processors 1130 and 1170 can direct (e.g., control, coordinate, manage, etc.) operation at base station 1110 and mobile device 1150, respectively. Respective processors 1130 and 1170 can be associated with memory 1132 and 1172 that store program codes and data. Processors 1130 and 1170 can also perform computations to derive frequency and impulse response estimates for the uplink and downlink, respectively.

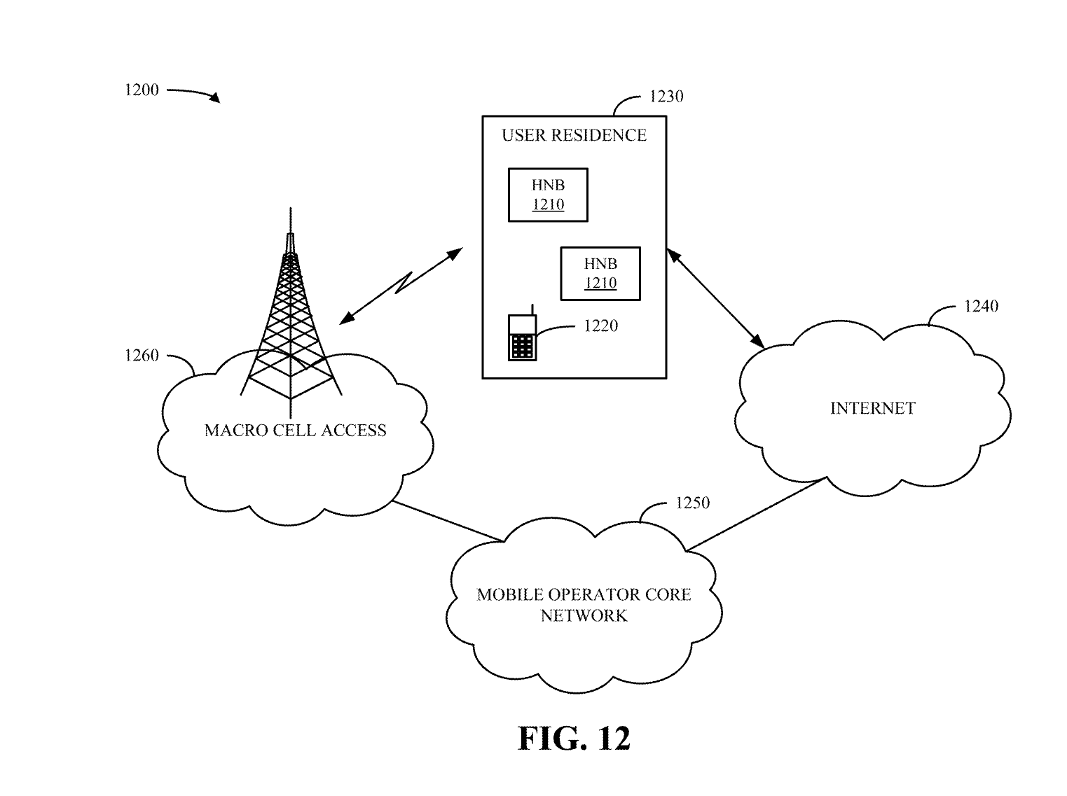

FIG. 12 illustrates an example communication system 1200 that enables deployment of access point base stations within a network environment. As shown in FIG. 12, system 1200 can include multiple access point base stations (e.g., femto cells or Home Node B units (HNBs)) such as, for example, HNBs 1210. In one example, respective HNBs 1210 can be installed in a corresponding small scale network environment, such as, for example, one or more user residences 1230. Further, respective HNBs 1210 can be configured to serve associated and/or alien UE(s) 1220. In accordance with one aspect, respective HNBs 1210 can be coupled to the Internet 1240 and a mobile operator core network 1250 via a DSL router, a cable modem, and/or another suitable device (not shown). In accordance with one aspect, an owner of a femto cell or HNB 1210 can subscribe to mobile service, such as, for example, 3G/4G mobile service, offered through mobile operator core network 1250. Accordingly, UE 1220 can be enabled to operate both in a macro cellular environment 1260 and in a residential small scale network environment.

In one example, UE 1220 can be served by a set of Femto cells or HNBs 1210 (e.g., HNBs 1210 that reside within a corresponding user residence 1230) in addition to a macro cell mobile network 1260. As used herein and generally in the art, a home femto cell is a base station on which an AT or UE is authorized to operate on, a guest femto cell refers to a base station on which an AT or UE is temporarily authorized to operate on, and an alien femto cell is a base station on which the AT or UE is not authorized to operate on. In accordance with one aspect, a femto cell or HNB 1210 can be deployed on a single frequency or on multiple frequencies, which may overlap with respective macro cell frequencies.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates employing interference cancellation during system acquisition, comprising:
detecting at least one undesired cell in a wireless communication network;
estimating a signal transmitted by the at least one undesired cell;
subtracting the estimated signal from a total received signal to produce a clean signal; and
acquiring a desired cell in the wireless communication network with the clean signal.

2. The method of claim 1, further comprising receiving a total signal that includes a transmission from a desired cell and the at least one undesired cell.

3. The method of claim 1, wherein the at least one undesired cell is a femto cell.

4. The method of claim 1, wherein the at least one undesired cell is a macro cell.

5. The method of claim 1, detecting the at least one undesired cell comprises discovering scrambling codes utilized by the at least one undesired cell.

6. The method of claim 5, estimating the signal comprises employing the scrambling codes of the at least one undesired cell to reconstruct the signal.

7. The method of claim 1, acquiring the desired cell comprises searching for at least one of synchronization signals, pilot signals or reference signals.

8. An apparatus, comprising:
a detection module that identifies signals transmitted by an interfering base station;
an estimation module that generates an approximation of signals transmitted by the interfering base station; and
a cancellation module that subtracts the approximation of signals from a total received signal.

9. The apparatus of claim 8, wherein the interfering base station is a femto cell for which the apparatus is not a member of an associated closed subscriber group.

10. The apparatus of claim 8, wherein the interfering base station is a macro cell.

11. The apparatus of claim 8, wherein the detection module identifies a scrambling code of the interfering base station.

12. The apparatus of claim 11, wherein the estimation module employs the scrambling code to generate the approximation of signals.

13. The apparatus of claim 8, further comprising an acquisition component that acquires service from a desired base station, the acquisition component utilizes an improved signal to acquire service, the improved signal is the total received signal with the approximation of signals subtracted by the cancellation module.

14. The apparatus of claim 13, the acquisition component identifies at least one of a synchronization signal, a pilot signal, or a reference signal of the desired base station.

15. The apparatus of claim 13, the acquisition component receives and demodulates a broadcast channel of the desired base station.

16. A wireless communication apparatus that facilitates interference cancellation, comprising:
means for detecting at least one undesired cell in a wireless communication network;
means for estimating a signal transmitted by the at least one undesired cell;
means for subtracting the estimated signal from a total received signal to produce a clean signal; and
means for acquiring a desired cell in the wireless communication network with the clean signal.

17. The wireless communication apparatus of claim 16, further comprising means for receiving a total signal that includes a transmission from a desired cell and at least one undesired cell.

18. The wireless communication apparatus of claim 16, wherein the at least one undesired cell is a femto cell.

19. The wireless communication apparatus of claim 16, wherein the at least one undesired cell is a macro cell.

20. The wireless communication apparatus of claim 16, means for detecting the at least one undesired cell comprises means for discovering a scrambling code utilized by the at least one undesired cell.

21. The wireless communication apparatus of claim 20, means for estimating the signal comprises means for employing the scrambling code of the at least one undesired cell to reconstruct the signal.

22. The wireless communication apparatus of claim 16, means for acquiring the desired cell comprises means for searching for at least one of synchronization signals, pilot signals or reference signals.

23. A computer program product, comprising:
a computer-readable medium, comprising:
code for causing at least one computer to identify signals transmitted by an interfering base station;
code for causing the at least one computer to generate a signal approximation of signals transmitted by the interfering base station; and
code for causing the at least one computer to cancel the signal approximation from a total received signal.

24. The computer program product of claim 23, wherein the interfering base station is a macro cell.

25. The computer program product of claim 23, wherein the computer-readable medium further comprises code for causing the at least one computer to ascertain a scrambling code of the interfering base station.

26. The computer program product of claim 25, wherein the computer-readable medium further comprises code for causing the at least one computer to employ the scrambling code to generate the signal approximation.

27. The computer program product of claim 23, wherein the computer-readable medium further comprises code for causing the at least one computer to acquire service from a desired base station.

28. The computer program product of claim 27, wherein the computer-readable medium further comprises code for causing the at least one computer to utilize an improved signal to acquire service, the improved signal is the total received signal with the signal approximation subtracted.

29. The computer program product of claim 27, wherein the computer-readable medium further comprises code for causing the at least one computer to identify at least one of a synchronization signal, a pilot signal, or a reference signal of the desired base station.

30. The computer program product of claim 27, wherein the computer-readable medium further comprises code for causing the at least one computer to receive and demodulate a broadcast channel of the desired base station.

31. A wireless communication apparatus, comprising:
a processor configured to:
detect at least one undesired cell in a wireless communication network;
reconstruct an approximate signal transmitted by the at least one undesired cell;
subtract the approximate signal from a total received signal to produce a clean signal; and
acquire a desired cell in the wireless communication network with the clean signal.

32. The wireless communication apparatus of claim 31, the processor is further configured to receive a total signal that includes a transmission from a desired cell and at least one undesired cell.

33. The wireless communication apparatus of claim 31, wherein the at least one undesired cell is a femto cell.

34. The wireless communication apparatus of claim 31, wherein the at least one undesired cell is a macro cell.

35. The wireless communication apparatus of claim 31, wherein the processor is further configured to discover scrambling codes utilized by the at least one undesired cell.

36. The wireless communication apparatus of claim 35, wherein the processor is further configured to employ the scrambling codes of the at least one undesired cell to reconstruct the approximate signal.

37. The wireless communication apparatus of claim 31, wherein the processor is further configured to search for at least one of synchronization signals, pilot signals or reference signals.

38. The wireless communication apparatus of claim 31, wherein the processor is further configured to scale the approximate signal prior to subtraction.
